(19) United States
(12) Patent Application Publication
(10) Pub. No.: US 2012/0018651 A1
(43) Pub. Date: Jan. 26, 2012

(54) NANOSCALE IMAGING OF MOLECULAR POSITIONS AND ANISOTROPIES

(75) Inventors: Samuel Timothy Hess, Stillwater, ME (US); Travis John Gould, Orono, ME (US); Mudalige Siyath Gunewardene, Stillwater, ME (US)

(73) Assignee: UNIVERSITY OF MAINE SYSTEM BOARD OF TRUSTEES, Bangor, ME (US)

(21) Appl. No.: 13/126,970

(22) PCT Filed: Oct. 30, 2009
(86) PCT No.: PCT/US09/05916

§ 371 Date: Oct. 17, 2011

Related U.S. Application Data
(60) Provisional application No. 61/109,992, filed on Oct. 31, 2008.

(51) Int. Cl. G01N 21/64; G02B 21/04; G02B 21/06

(52) U.S. Cl. 250/459.1; 359/385; 359/386

(57) ABSTRACT

A Polarization Fluorescence Photoactivation Localization Microscopy (P-FPALM) system and method are provided to simultaneously image the localizations and fluorescence anisotropics of large numbers of single molecules within a sample. The system modifies known FPALM systems by adding a polarizing beam splitter. The beam splitter polarizes emissions perpendicular and parallel to an axis in the sample to allow spatially separate imaging of fluorescence emitted from a sample. The system includes lenses and mirrors so that the separate, polarized beams are detected simultaneously. The present invention includes methods of using the system to image localizations and fluorescence anisotropics of single molecules, and methods of using data obtained with the system to predict 3-D orientation of the molecules. The system and method achieve substantially improved lateral resolution within even dense samples over known microscopic imaging techniques, and does not compromise speed or sensitivity.

### FIELD OF THE INVENTION

The present invention relates to a system and method of imaging at a nanoscale level. More particularly, the present invention is a system and method for imaging single molecule polarization anisotropy in biological specimens.

### BACKGROUND OF THE INVENTION

For a complete understanding of cellular biology we ideally need to observe the cell at a molecular level. Single-molecule detection gives extra statistical information and allows the exploration of heterogeneity in samples, as well as direct observation of dynamic state changes arising from photophysics and photochemistry. For every distinct molecule it can be useful to know the number of its kind present, the precise location of each member of the ensemble of identical molecules, and the functionality of each member of the ensemble. Such observations can only be made by single molecule microscopy, since standard imaging methods, which make ensemble measurements that average over many molecules, do not provide quantitative information about each molecule.

Light microscopy provides non-invasive imaging of multiple species in biological specimens with single-molecule sensitivity, but diffraction limits the resolution to ˜150-250 nm. Since many biological processes occur on smaller (molecular) scales, techniques which can image below the diffraction limit and yield single-molecule information are becoming increasingly important.

A recently developed method can break the diffraction barrier to achieve effective resolution in the 10-40 nm range by localization of large numbers of single molecules. In this method, small subsets of photoactivatable fluorescent molecules (initially in a non-fluorescent state) such as photoactivatable fluorescence proteins are stochastically activated within the sample by illumination with an activation laser. Only photoactivated molecules fluoresce when illuminated by a second (readout) laser. Those fluorescent molecules are imaged and then deactivated (quenched), either actively or by spontaneous photobleaching. The process is repeated until data has been acquired on a sufficiently large number of molecules, or all possible molecules. Image analysis is used localize each molecule and determine its intensity.

The localization-based method can image living cells, three-dimensional specimens, and multiple species. However, despite its impressive capabilities, this method does not provide information about the anisotropy and rotational freedom of individual molecules. This information can be used to test the degree of interaction between molecules in biological systems. Furthermore, understanding organization and functionality of molecular machines often requires determination of the orientation of molecules within cellular structures and relative to one another.

Previous imaging of single molecule anisotropies (a measure of the orientation of the transition dipole moment of a fluorescent molecule) has relied on near-field methods, shape analysis of molecular images obtained by diffraction-limited techniques, or other methods of imaging which can only be utilized in relatively sparse distributions of molecules. Therefore, a device and method to obtain both (i) high-density maps of (ii) single molecule positions and anisotropies is needed in the art.

### SUMMARY OF THE INVENTION

It is an object of the present invention to provide a system and method for imaging the position and anisotropy of single molecules in biological specimens. The system and method are based on fluorescence photoactivation localization microscopy (FPALM) and are configured to provide resolution well below the diffraction limit. In particular, the present invention adapts FPALM with a modified detection path, and is termed polarization-FPALM (P-FPALM).

The system of the present invention incorporates a polarizing beam splitter into the detection path of a standard FPALM microscope. This modification allows simultaneous, spatially separate imaging of the fluorescence emitted by a molecule, and this emission is polarized parallel and perpendicular to the excitation polarization. The present invention also modifies the standard FPALM system by adding lenses which expand the emitted fluorescent image paths after polarization, and additional mirrors which adjust the two detection paths to have the same or nearly the same total length from the beam splitter to the image detector. The method of the present invention analyzes the relative intensities of molecules in the two images to yield the anisotropy of each localized molecule. Two-dimensional maps (images) of single-molecule anisotropy can be obtained with significantly improved spatial resolution.

In one example of the system and method of the present invention, the sample is placed on the stage of any suitable microscope together with a suitable imaging lens. The use of a water-immersion lens is advantageous because it minimizes aberrations when imaging a sample that is also in water. The sample is illuminated using a light source of suitable wavelength. In one embodiment of the present invention the light source used is a laser. In another embodiment the light source of the microscope system includes two lasers: an activation laser and a readout laser of suitable wavelength. The light source is focused in the objective back-aperture to cause a large area of the sample to be illuminated.

In one embodiment, illumination using a relatively unfocused Gaussian beam is advantageous because it reduces the tipping of the polarization toward the z-axis which results from a high-numerical aperture diffraction-limited focus. In another embodiment, the intensities of the illumination light source are modulated at one or more wavelengths. This modulation can be accomplished using a mechanical or optical shutter or an electrooptic modulator such as a Pockel's cell. This modulation allows sequences of optical pulses to prepare sample molecules in different photophysical states. In yet another embodiment, polarization of the illumination light source is modulated using mechanical or optical shutters which allow illumination light of different polarizations to pass. In embodiments using two lasers as the illumination light source, either the activation or readout beam or both may be modulated in this way. One embodiment includes splitting the illumination light into two or more separate paths with different polarizations that are independently shuttered. Another embodiment modulates the illumination polarization using an electrooptic modulator such as a Pockel's cell. This modulation will allow molecules with different orientations to be selectively excited.

Fluorescence detected by the same objective is filtered using one or more dichroic mirrors and interference filters. The resulting fluorescence is focused by a suitable lens to form an intermediate image which is expanded or magnified before entering the polarizing beam splitter. The reflected beam (lower path, light polarized in the x-direction at the sample) is directed to a suitable detection system such as an electron-multiplying charge coupled device (EMCCD) camera by a first mirror, while the transmitted beam (upper path, light polarized in the y-direction at the sample) is directed to the same EMCCD by second and third mirrors. The second and third mirrors are adjusted so that the total length of both paths is equal or nearly equal.

Because single molecules are being localized using two detection channels (three channels are required to determine the full orientation in three dimensions), anisotropies measured for molecules which are oriented with a component out of the x-y plane will only be approximate, due to tipping of the polarization by the high-numerical aperture objective. As a result, the anisotropies cannot be interpreted directly as an angle relative to the laser polarization axis, but calculations accounting for the effects of polarization tipping (see discussion below) allow specification of the range of orientations the molecule could have, within experimental error, when close to the center of the field.

For analysis, the fluorescence transmitted and reflected by the polarizing beam splitter are first correlated with each other using any suitable method, such as by using images of fluorescent beads. The image of the reflected fluorescence is shifted, rotated, and stretched linearly in the x- and y-directions (conserving the total number of detected photons), to produce the best normalized cross-correlation with the image of the transmitted fluorescence. The transformation parameters measured from the bead images are then used to transform all subsequent images. The anisotropy of one or more single molecules is then calculated from the ratio of fluorescence emitted by the molecule and detected with polarization parallel and perpendicular to the laser with resolution significantly better than what has been achieved in the art.

It is another object of the present invention to provide a method for imaging the position and anisotropy of single molecules in samples using the system described above. In one embodiment the method is used to image a biological sample. The method includes the first step of placing a sample on the stage of a suitably modified microscope, wherein the microscope is an FPALM microscope with a modified detection path including a polarizing beam splitter, lens or lenses to expand the reflected and transmitted beams emerging from the polarizing beam splitter, and mirrors which equalize or nearly equalize the path length of the reflected and transmitted beams so that they are captured by a detector at substantially the same time. The method includes additional steps of illuminating the sample, detecting the parallel and perpendicularly polarized images which are emitted, and calculating the position and anisotropy of single molecules within the sample. Additional calculations may also be made, and are within the scope of the method of the present invention.

The ability to image anisotropy with resolution below the diffraction limit presents several interesting opportunities, most importantly the ability to image short-range order and to quantify the degree of preferential orientation of molecules. As long as the limitations of the method are taken into account, we can use the anisotropy to estimate the degree of alignment (but not the precise angle) between the transition-dipole moment of the emitting molecule (the fluorophore) and the excitation laser beam polarization. Interactions between membrane domains and the cytoskeleton, such as those found in focal adhesions, are expected to result in preferential orientation of molecules, but the size of those structures is generally well below the diffraction limit. The improved resolution in P-FPALM will allow quantification in the order of proteins and lipids in membrane domains at length scales inaccessible to standard methods.

In addition to its dramatically improved spatial resolution, P-FPALM provides absolute numbers of molecules and can quantify heterogeneous populations of molecules, both which are inaccessible to conventional methods. P-FPALM provides a means to measure molecular positions and orientations in biological structures in a crucial, but previously inaccessible, range of length scales. Furthermore, P-FPALM will be compatible with live-cell FPALM, PALM (photo-activated localization microscopy) and STORM (stochastic optical reconstruction microscopy) using widefield excitation, and with multi-color imaging.

In live-cell applications, the anisotropy may be used to distinguish between molecules which are bound and unbound: for example, a ligand which binds to a membrane receptor will no longer access all orientations, and will in some cases show greater anisotropy than an unbound copy of the same molecule. This kind of approach will be useful for studies of protein-protein interactions, polymerization,

depolymerization, growth and collapse of intracellular structures, lateral organization in membranes, and other applications involving molecular orientations. Since high excitation intensities are potentially damaging to cells, users of P-FPALM may need to make appropriate control experiments to check for any effects of the high intensity illumination on cell viability.

Longer acquisitions may allow higher molecular densities to be observed in well-immobilized samples. Extension of the technique to three-dimensional (3D) imaging is both possible and useful, considering that structures such as actin will span many focal planes. Hence, 3D imaging would capture larger numbers of total molecules in different focal planes and allow extended structures to be visualized even more comprehensively.

These and other advantages and aspects of the system and method of the present invention will become apparent upon review of the following detailed description, the accompanying drawings, and the appended claims.

### BRIEF DESCRIPTION OF THE DRAWINGS

FIG. 1 is a schematic depiction of the P-FPALM system, which illustrates the modifications made to a standard FPALM system.

FIG. 2 includes representative acquisition, rendering, and detection parameters for use in carrying out the system and method of the present application with the particular samples indicated in column 1.

FIG. 3, comprising FIGS. 3A-3D, is a P-FPALM image of PGFP dried on a glass coverslip. The scale bar in FIG. 3A is 1 μm, and the scale bar in FIG. 3B is 250 μm.

FIG. 4A is a P-FPALM image of Dendra2-actin expressed in fixed fibroblast cells, revealing the molecular order of actin along filament-like structures.

FIG. 4B is a zoom-in of the boxed region in FIG. 4A demonstrating gradients in single molecule anisotropy, as marked by arrows and ellipses.

FIGS. 5A-H are P-FPALM images of Dentra2-actin expressed in fixed fibroblasts. The scale bar for FIGS. 5A, C, E and G is 1 μm, and the scale bar for FIGS. 5B, D, F, and H is 250 μm.

FIGS. 6A and B are transmitted light images obtained under low magnification for fixed fibroblasts (FIG. 6A), and fibroblasts treated with cytochalasin D for 60 minutes prior to fixation (FIG. 6B).

FIGS. 7A and 7B are P-FPALM images of Dendra2-actin expressed in a fibroblast treated with cytochalasin D for 60 minutes prior to fixation.

FIGS. 8A-H are P-FPALM images of Dentra2-actin expressed in fixed fibroblasts treated with cytochalasin D for 60 minutes prior to fixation. The scale bar for FIGS. 8A, C, E and G is 1 μm, and the scale bar for FIGS. 8B, D, F, and H is 250 μm.

FIG. 9 is a cumulative distribution of single molecule anisotropies for PGFP on coverglass (dashed black line) and fixed fibroblasts expressing Dendra2-actin (solid thin line, no cytochalasin D; solid thick line: 60 minute treatment with cytochalasin D).

FIG. 10, comprising FIGS. 10A-10J, shows histograms of anisotropy for selected P-FPALM images of fibroblast cells (top) and fibroblast cells treated with cytochalasin D for 60 minutes (bottom). The corresponding cell image numbers are shown in parentheses.

FIG. 11A is a P-FPALM image of PGFP-HA expressed in a fixed fibroblast with a scale bar of 1 μm. FIG. 11B is a zoom in of the boxed region in FIG. 11A with a scale bar of 250 μm. FIG. 11C is a distribution of single molecule anisotropies for all molecules localized in the cell shown in FIG. 11A, and FIG. 11D is a distribution of the localization precision for all molecules shown in FIG. 11A.

FIG. 12, comprising FIGS. 12A-12J, shows histograms of localization precision for selected P-FPALM images of fibroblasts (top) and fibroblasts treated with cytochalasin D for 60 minutes (bottom).

FIG. 13 is a model of the fluorescence detected in P-FPALM. The circle represents a single molecule emitting dipole radiation according to its transition dipole moment (arrow).

FIG. 14 illustrates the detected electric field from a dipole near the focus of a water-immersion objective lens, with the dipole oriented along x, y, and z, as a function of the position of the dipole in the xy plane.

FIG. 15 shows measured and Monte-Carlo simulated P-FPALM anisotropy histograms for a standard fluorophore.

FIG. 16 is the expected detected anisotropy as a function of single-molecule orientation near the center of the field in a P-FPALM system. The shading on the surface of the sphere indicates the detected anisotropy value (see scale bar) for a molecule with transition dipole moment pointing from the origin to the surface at that point.

### DETAILED DESCRIPTION OF THE PREFERRED EMBODIMENTS OF THE INVENTION

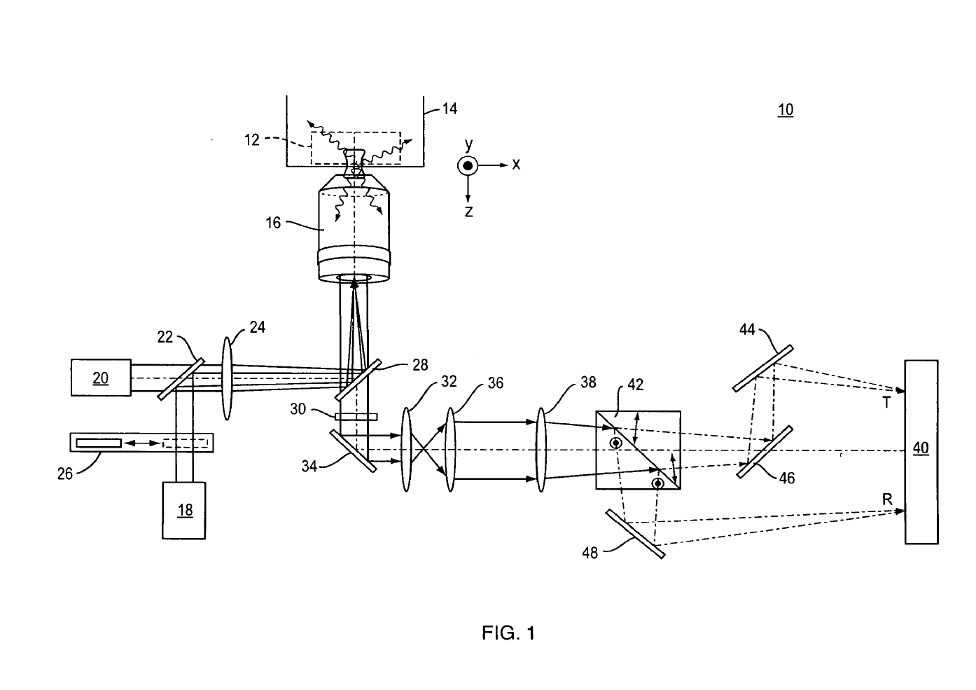

Referring to FIG. 1, a representative example of an imaging system 10 of the present invention includes a standard two-dimensional Fluorescence Photoactivation Localization Microscopy (FPALM) system with a modified detection path. A sample 12 labeled with a suitable fluorophore is placed on the stage 14 of any suitable microscope together with a suitable imaging lens 16. One representative but non-limiting example of a suitable microscope is the Olympus IX-71 inverted microscope (Olympus America, Melville, N.Y.) with a 60×1.2 NA water-immersion objective (UPLAPO60XW, Olympus) as the imaging lens. The use of a water-immersion lens is beneficial because it minimizes aberrations when imaging a sample that is also in water, as is the case with many biological samples. High numerical aperture lenses and other types of immersion lenses such as oil-immersion, glycerol-immersion, and air immersion lenses are also well-suited for use in the present application.

The sample 12 is illuminated over a large area using a light source such as activation 18 and readout 20 lasers shown in FIG. 1 of wavelengths selected appropriately for each fluorophore. The emitted beams are combined into an approximately collinear path using a suitable dichroic mirror 22 (such as Z405RDC, Chroma Technology, Rockingham, Vt.) and focused by a suitable lens 24 (such as f=+300 mm, Newport Corporation, Irvine, Calif.) to form a waist near the back aperture of the imaging lens 16 after being reflected by one or more suitable dichroic mirrors represented as mirror 26. Lasers of 405 nm activation 18 and 488 nm readout 20 for PGFP, or 405 nm activation 18 and 556 nm readout 20 lasers for the Dendra2 are non-limiting examples of suitable lasers 18, 20 which may be used with the system 10 and method of the present invention. The lasers 18, 20 are focused near the imaging lens 16 back-aperture to cause an area of the sample to be illuminated with linear polarization along the x- or y-directions, or along another direction, or with elliptical or circular polarization. Whether the activation laser 18 illuminates the sample 12 or not may be controlled using known shutter technologies or the like (see shutter 28 in FIG. 1).

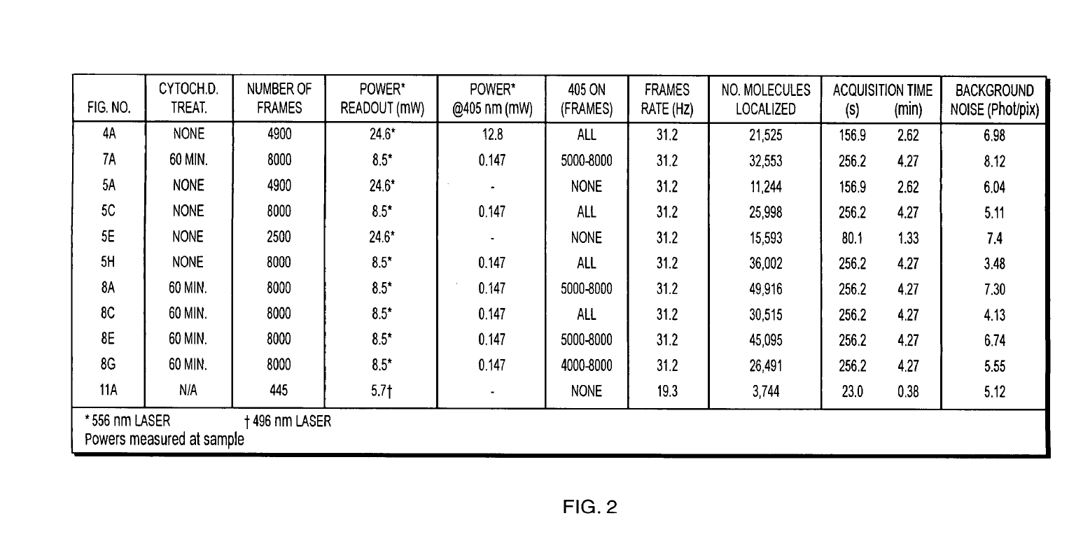

Fluorescence detected by the imaging lens 16 is reflected and filtered by the one or more dichroic mirrors 26 and one or more interference filters represented as filter 30. Any mirrors and filters suitable for use with a particular fluorophore may be used as mirrors 26 and filters 30, such as mirror T565LP and filter ET605/70M for use with Dendra2, or mirror Z488RDC and filter HQ535/50M with PGFP (mirrors 26 and interference filters 30 are available from Chroma Technology, Rockingham, Vt.). The fluorescence detected by the imaging lens 16 is separated from the light source by the one or more dichroic mirrors 26, band-pass filtered with filter 30, and reflected on to a suitable lens 32 such as a tube lens using a mirror 34 (note that the system 10 of the present invention may be configured with or without mirror 34). The fluorescence is focused by the lens 32 to form an intermediate image behind the lens. The intermediate image is magnified using one or more lenses 36, 38. One non-limiting example uses telescope lenses 36, 38 of +60 mm and +200 mm achromats to result in an overall magnification of ˜192 and an effective pixel size in object space of 83.3 nm (f=+60 cm and f=+200 cm lenses from Newport Corporation, Irvine, Calif.). In a standard FPALM system, the magnified image is then detected with any suitable detector 40, such as with an EMCCD camera at 10-33 frames per second for ˜100-1000 seconds (iXon+ DU897DCS-BV, Andor Technology, South Windsor, CT). Appropriate activation and illumination pulse protocols may be readily determined by those skilled in the art. Representative acquisition, rendering, and detection parameters are shown in FIG. 2.

In the system 10 of the present invention, a polarizing beam splitter 42 is placed in the detection path in front of the detector 40 to separate the detected fluorescence into components polarized parallel and perpendicular to the internal interface of the beam splitter 42. Any suitable polarizing beam splitter 42 may be used in the system 10 of the present invention, such as a broadband polarizing cube beam splitter (10FC16PB.3 from Newport Corporation, Irvine, Calif.). Additional mirrors 44, 46, 48 are employed in the system 10 so that the total path length from tube lens to camera for both detection paths is identical or nearly identical, as is the angle of incidence of the pathways upon reaching the detection device such as a camera. As can be seen in FIG. 1, in the system 10 depicted, the transmitted beam (T) uses mirrors 44 and 46, and the reflected beam (R) uses mirror 48. These mirrors 44, 46, 48 also direct each detection path to spatially separated locations on the same detector 40 such as a camera.

Analysis of the reflected (R) and transmitted (T) beam images shown in FIG. 1 are correlated with each other after passing through the polarizing beam splitter 42. Any suitable method of correlation may be used, such as using images of fluorescent beads. For example, a sample for correlation may be made with a 1.0 μl droplet of ˜100 nM, 100 nm fluorescent beads (FluoSpheres, Molecular Probles/Invitrogen, Carlsbad, Calif.) placed on a #1.5 glass coverslip (Corning Life Sciences, Corning, N.Y.) and allowed to evaporate slowly. Image R is shifted, rotated, and stretched linearly in the x- and y-directions (conserving the total number of detected photons), to produce the best normalized cross correlation with image T. The transformation parameters measured from the bead images are then used to transform all subsequent images.

The anisotropy (r) is then calculated from the ratio of fluorescence emitted by the molecule and detected with polarization parallel (I_{∥}) and perpendicular (I⊥) to the laser, respectively, using Equation 1: r=(I_{∥}−I⊥)/(I_{∥}+2I⊥). Localization precision and effective resolution may also be calculated, as discussed in detail below.

Prior to calculation, the I_{∥} and I⊥ are background subtracted and corrected for bleed-through and relative detection efficiency. As a control, mean anisotropy values can be determined using a suitable sample, such as rhodamine B in low- and high-viscosity solutions. When this comparison was carried out, the anisotropy values obtained using the present invention were found to agree within uncertainty with results published previously, demonstrating the accuracy of the method on a sample with known anisotropy values (see discussion below for greater detail).

The system 10 and method of the present invention may be used with a wide variety of biological samples tagged with suitable fluorophores. For non-limiting illustrative purposes, the method of the present invention will be described with three samples: photoactivatable green fluorescent protein (PGFP) on glass, a Dendra2-actin protein construct expressed in fibroblast cells, and fibroblast cells tagged with PGFP-HA or Dendra2-HA. With all samples it may be useful to attempt to reduce background signal from fluorescent contaminants in the buffer by using UV-bleached buffers or high purity liquid chromatography (HPLC) grade water (Sigma-Aldrich, MO) or the like.

For the PGFP samples, solutions of PGFP were diluted in UV-treated HPLC grade water (Sigma-Aldrich, MO). A ˜0.5 μl droplet of the solution was placed and spread on a #1.5 glass coverslip (Corning Life Sciences, NY) and allowed to evaporate slowly.

For the Dendra2-actin construct, a humanized version of the Dendra2 gene from pDendra2-C vector (Evrogen, Moscow, Russia) was swapped with the EGFP sequence in pEGFP-actin plasmid (Clontech, CA), resulting in the pDendra2-actin plasmid encoding the Dendra2-actin fusion protein. For production, plasmids were transformed into chemically competent DH5α bacterial host. The plasmid minipreps were obtained using QIAprep Spin kit (Qiagen, MD) after overnight culture.

For the HAb2 fibroblasts, fibroblasts were grown to ˜80% confluence on eight-well chambers with #1.5 coverslip bottoms (Labtek II, Nalge-Nunc International Corp.) in Dulbecco's modified eagle medium (Gibco/Invitrogen) supplemented with 10% calf bovine serum (ATCC) with neither phenol red nor antibiotics. Cells were transfected with ˜1 μg per well of pDendra2-actin or PGFP-HA using Lipofectamine 2000 (Invitrogen) in Opti-MEM reduced-serum media (Gibco/Invitrogen) without antibiotics according to the manufacturer's directions and then grown for an additional 24-30 hours. For fixation, cells were removed from the incubator, rinsed three times in UV-bleached PBS (see below), incubated for about 30 minutes in 4% paraformaldehyde (Sigma-Aldrich) in PBS at room temperature, and rinsed three more times with UV-bleached PBS. To disrupt the actin cytoskeleton, cells were incubated with 1 μM cytochalasin-D (C2618, Sigma-Aldrich, MO) at 37° C. for 60 minutes before fixation. The cytochalasin-D stock was dissolved in PBS at room temperature.

The samples 12 are examined using the system 10 of the present invention. Each sample 12 is illuminated over a large area using an appropriate light source such as activation and readout lasers 18, 20 selected in accordance with the fluorophore present in each sample 12. See FIG. 2 for suitable image acquisition parameters. The fluorescence detected by the imaging lens 16 is filtered by one or more dichroic minors 22 and interference filters 30, and then magnified by lenses 32, 36, 38 before passing through the polarizing beam splitter 42. After polarization, the path lengths of the transmitted and reflected beam images are equalized or nearly equalized using minors 44, 46, 48, and the image is detected using a detector 40. The anisotropy of molecules can be calculated from the ratio of fluorescence emitted by the molecule with polarization parallel and perpendicular to the laser 20.

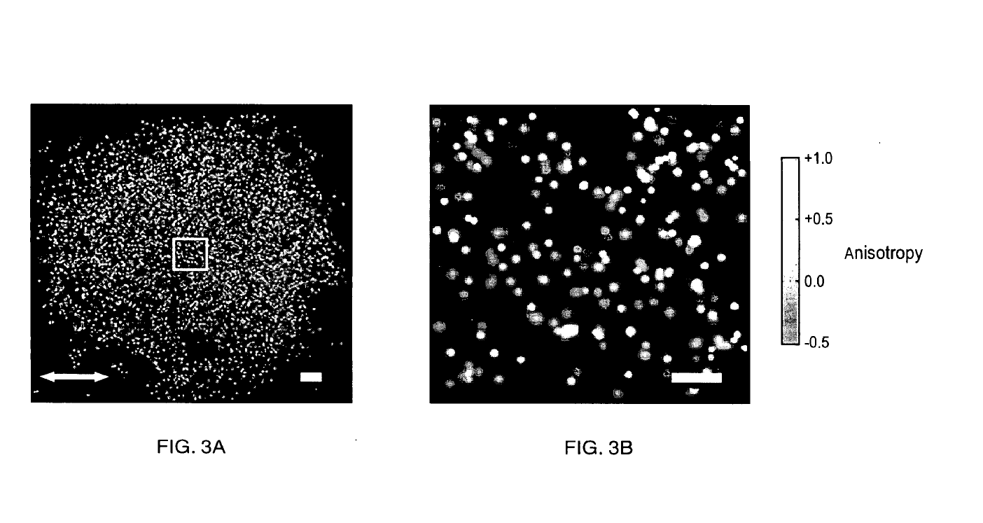

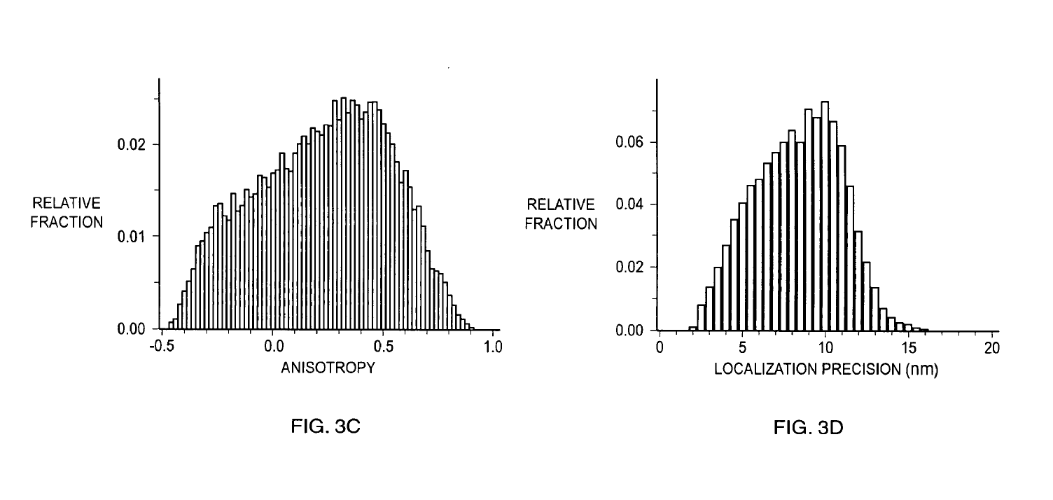

The results from using the system 10 and method of the present invention on the samples 12 described above are as follows. As shown in FIG. 3, PGFP molecules on glass show little spatial dependence of the anisotropy. FIG. 3A is a P-FPALM image of PGFP dried on a glass coverslip (22,452 localized molecules). Note the most frequent value for r is not zero. The spatial dependence of the anisotropy for the PGFP on glass is weak, demonstrating that the differences observed in other samples below, such as Dendra2-actin in fibroblasts, are significant. FIG. 3B shows a zoom-in of the boxed region in FIG. 3A. The grey scale bar indicates anisotropy for FIGS. 3A and 3B. FIG. 3C shows a distribution of single molecule anisotropies of the molecules shown in FIG. 3A. FIG. 3D shows the distribution of localization precision of single molecules in FIG. 3A as calculated by Equation 2, discussed below.

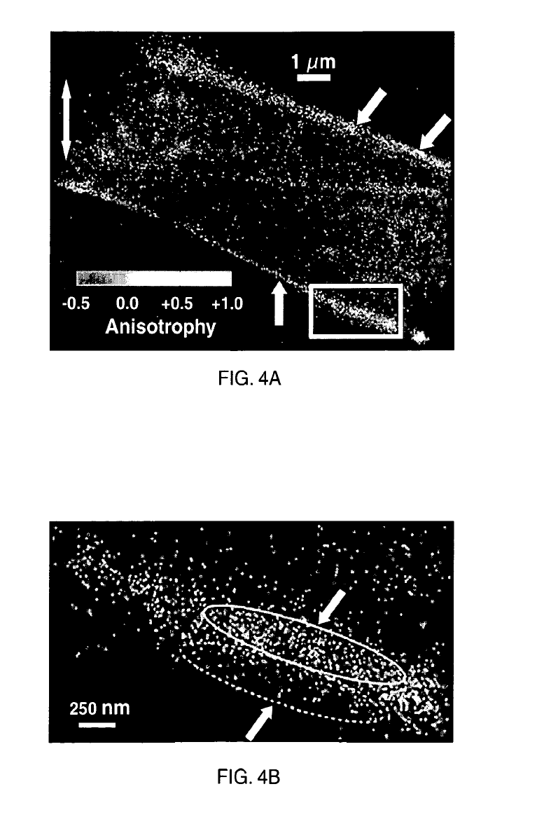

FIGS. 4A and 4B show positions and grey scale-coded anisotropy values of localized Dendra2-actin molecules (21,525 molecules) imaged in a fixed fibroblast cell. In FIG. 4A, the double headed arrow indicates the direction of polarization of the read-out beam. FIG. 4B is a zoom-in of the boxed region in FIG. 4A, demonstrating gradients in single molecule anisotropy (2,015) molecules, as marked by arrows and ellipses. The white arrows in FIGS. 4A and 4B point out regions within the cell with consistently negative or consistently positive anisotropy values, and the grey scale bar indicates the anisotropy scale.

Molecules localized in cells transfected with Dendra2-actin show elongated filament-like structures visible on the edges and within the interior. Clear patterns in the distribution and anisotropy values of molecules can be observed. Actin fiber bundle density is expected to affect the measured anisotropy by limiting or permitting certain probe orientations. The effective resolution (see discussion below for calculating effective resolution) of ˜26 nm for the structure shown in FIG. 4B is limited by the localization precision (˜7 nm median value), but more so by the density of localized molecules (˜25 nm median nearest neighbor distance). Molecules localized in the extended fiber bundles have obvious gradients in their anisotropy; some regions contain mostly molecules emitting parallel to the direction of the excitation (dark grey-colored molecules in the middle of the upper fiber bundle in FIG. 4A and lower side enclosed in the dashed ellipse of the fiber bundle in FIG. 4B). In another region within the same structure (see right-most arrow in upper right of FIG. 4A), the majority of molecules emitted fluorescence polarized perpendicular to the excitation direction. The opposite trend of perpendicular to parallel is observed from left to right in the lower edge of the cell in FIG. 4A (see also FIG. 4B).

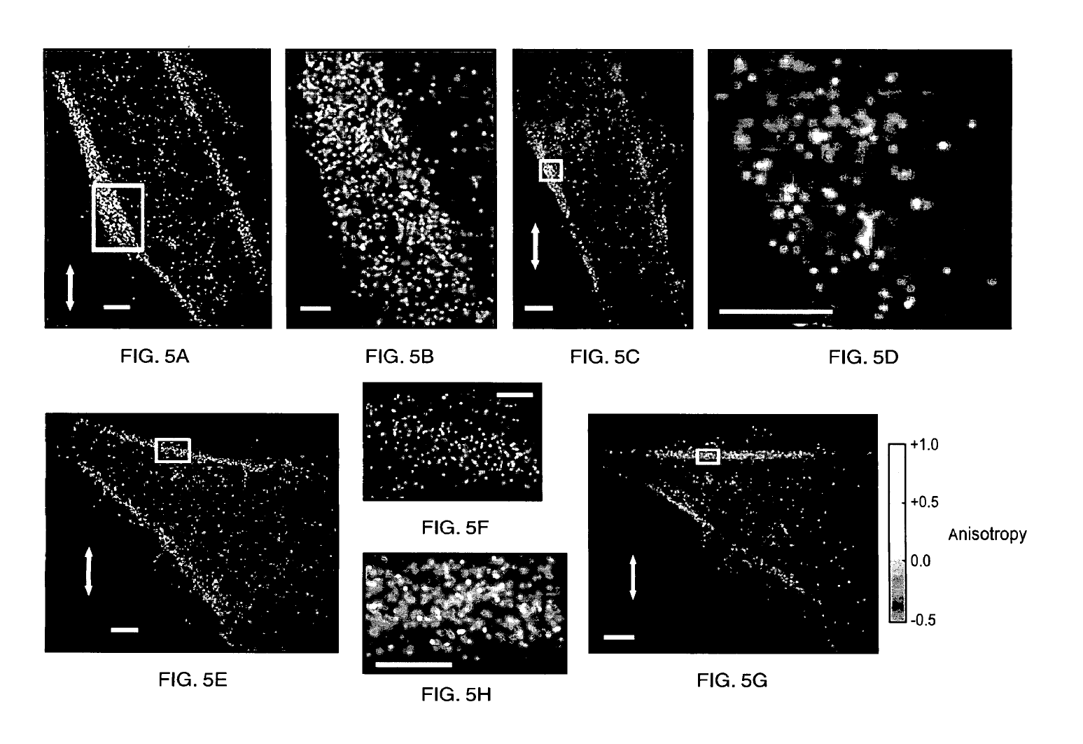

FIG. 5 shows additional P-FPALM images of Dendra2-actin expressed in fixed fibroblasts. Note the presence of filamentous structures of actin that show clear trends in single molecule anisotropy. FIG. 5A illustrates 11,244 molecules, and FIG. 5B is a zoom-in of the boxed region in FIG. 5A with 2,287 molecules. FIG. 5C illustrates 25,998 molecules, and FIG. 5D is a zoom-in of the boxed region in FIG. 5C of 1,198 molecules. FIG. 5E illustrates 15,593 molecules, and FIG. 5F is a zoom-in of the boxed region in FIG. 5E of 642 molecules. FIG. 5G illustrates 36,002 molecules, and FIG. 5H is a zoom-in of the boxed region in FIG. 5G of 1,136 molecules. The white arrows indicate the polarization of the 556 nm read-out laser, and the grey scale bar indicates the anisotropy for FIGS. 5A-H.

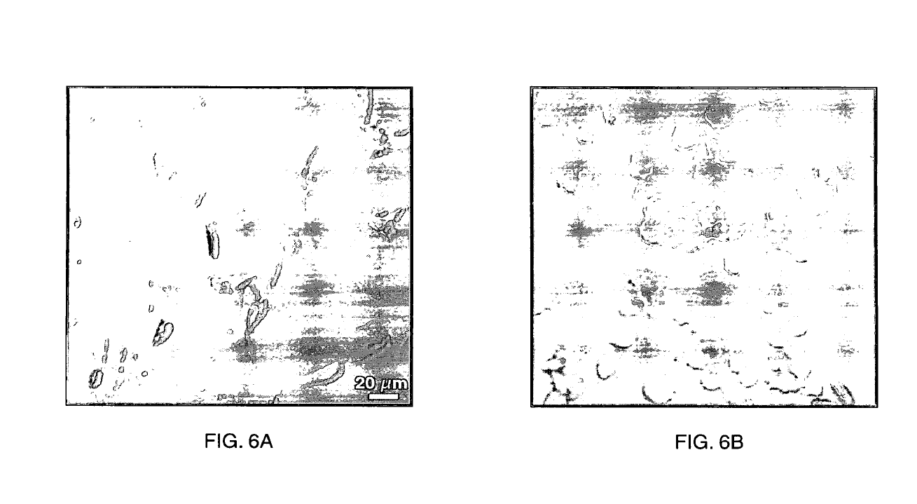

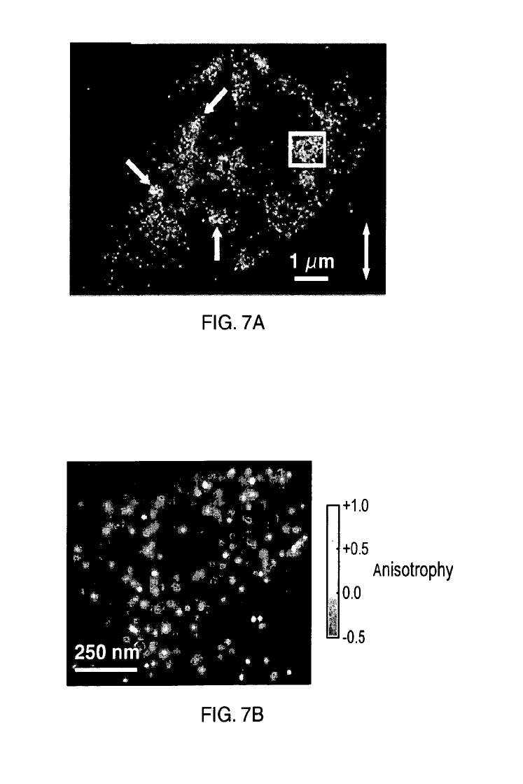

To test whether these trends in anisotropy correspond to filamentous actin structures, cells were treated with 1 μM cytochalasin-D for 60 minutes to disrupt the actin cytoskeleton before fixation and imaging. As shown in FIG. 6, which is a transmitted light image under low magnification for fixed fibroblasts (FIG. 6A) and fibroblasts treated with cytochalasin D for 60 minutes before fixation (FIG. 6B), the cell structure changes drastically and the cells have rounded up. As can be seen in FIGS. 7A and 7B, the fiber-like bundles are no longer visible, and the structures which remain show very little trend in the anisotropy. The grey scale bar indicates the anisotropy scale in FIGS. 7A and 7B.

Referring to FIG. 7A, both the clear order of single molecule anisotropy and the elongated actin structures are no longer visible after treatment with cytochalasin D (32,553 molecules). The double headed arrow indicates the direction of polarization of the read-out beam, and white arrows indicate globular clusters of Dendra2-actin. FIG. 7B is a zoom-in of the boxed region of FIG. 7A (1,878 molecules), and shows a mixture of molecules emitting parallel and perpendicular to the excitation. As can be seen in FIG. 7B, among all treated cells that were imaged, none showed distinct filamentous structures or anisotropy patterns like the ones observed in untreated cells. Within the ˜1 μm sized globular clusters that are visible, we observe a mixture of molecules emitting parallel and perpendicular to the excitation.

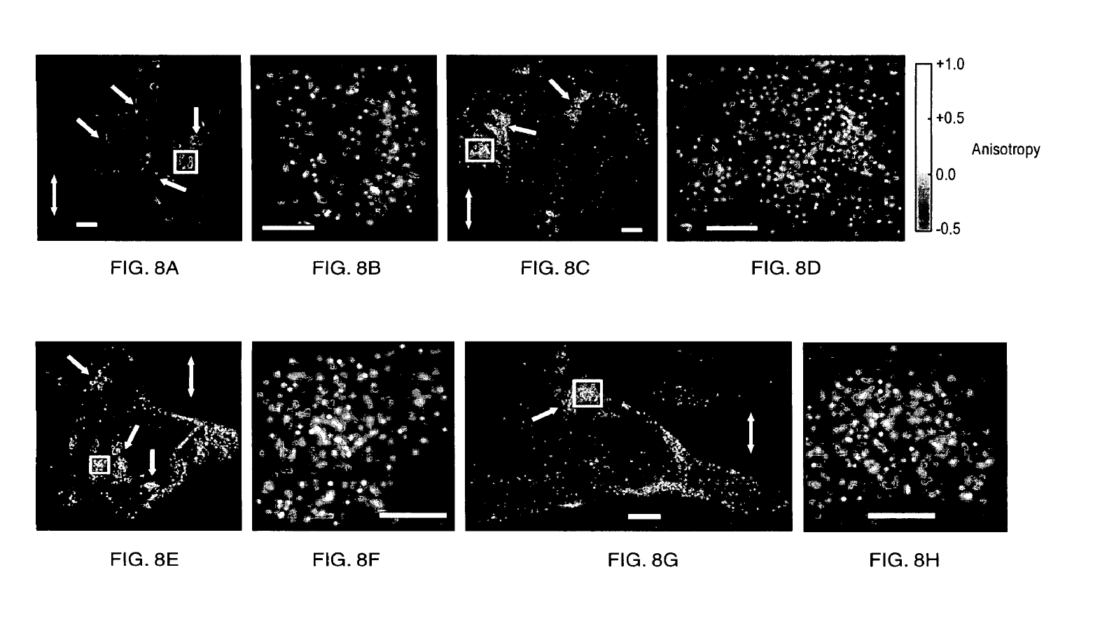

FIG. 8 shows additional P-FPALM images of Dendra2-actin expressed in fixed fibroblasts incubated in 1 μM cytochalasin D for 60 minutes before fixation. FIG. 8A illustrates 49,916 molecules, and FIG. 8B is a zoom-in of the boxed region in FIG. 8A with 2,334 molecules. FIG. 8C illustrates 30,515 molecules, and FIG. 8D is a zoom-in of the boxed region in FIG. 8C of 2,794 molecules. FIG. 8E illustrates 45,095 molecules, and FIG. 8F is a zoom-in of the boxed region in FIG. 8E of 1,612 molecules. FIG. 8G illustrates 26,491 molecules, and FIG. 8H is a zoom-in of the boxed region in FIG. 8G of 1,794 molecules. The double headed arrows indicate the polarization of the 556 nm read-out laser, and the grey scale bar indicates the anisotropy for FIGS. 8A-H.

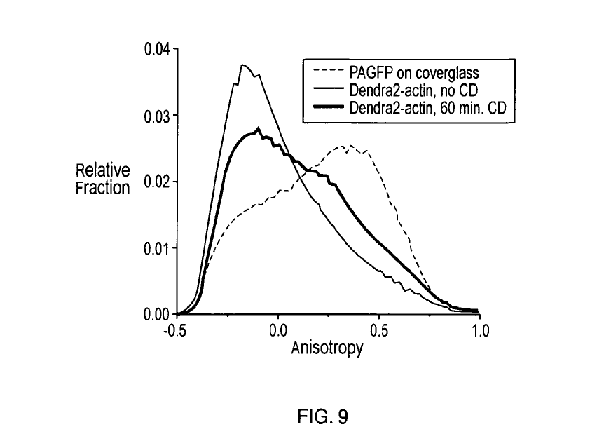

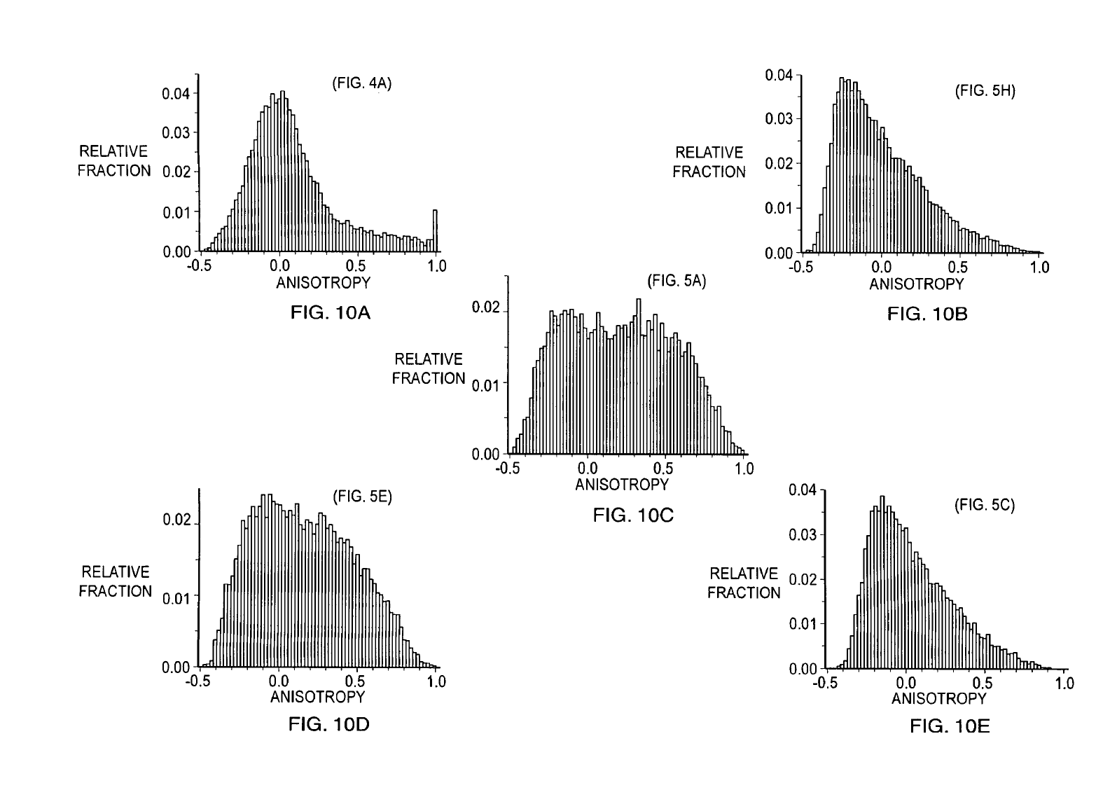

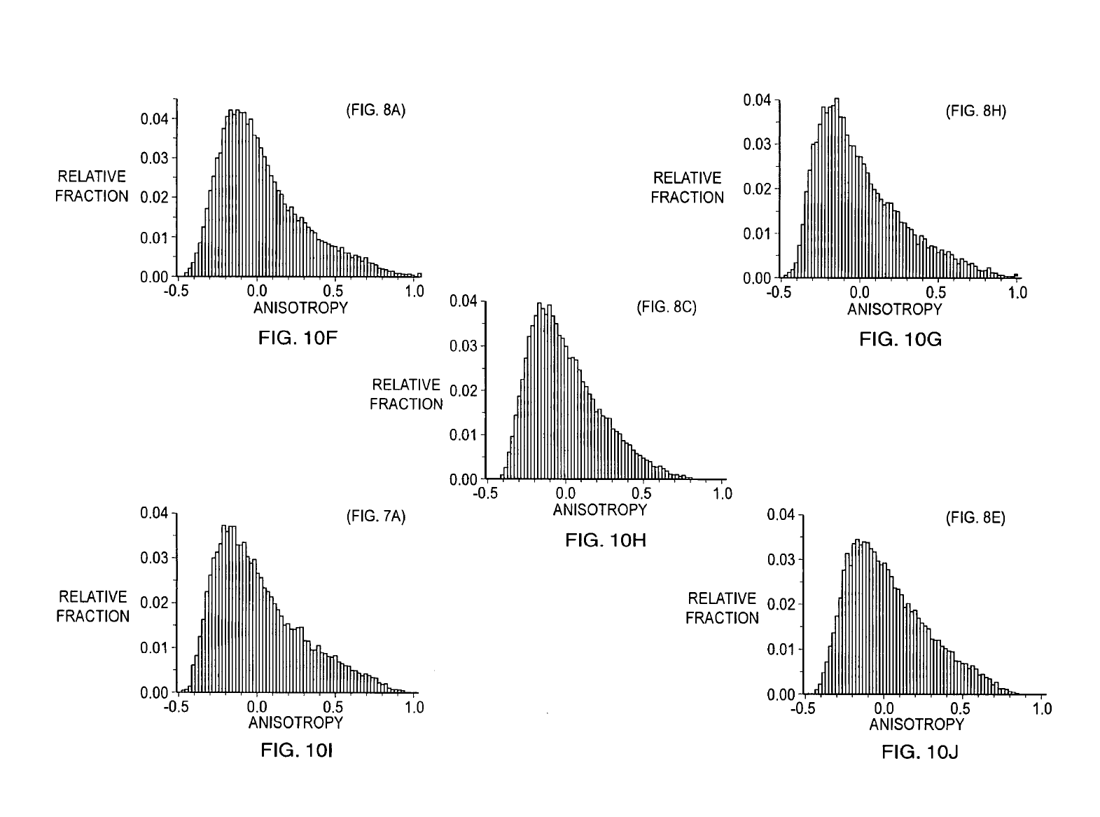

FIG. 9 is a cumulative distribution of single molecules for PGFP on coverglass (dashed black line, n=10 cells, and 108,399 total molecules) and fixed fibroblasts expressing Dendra2-actin (solid thin line: no cytochalasin D, n=30 cells, 496,844 total molecules; solid thick line: 60 minute treatment with cytochalasin D, n=5 cells, 187,457 total molecules. As can be seen in FIG. 9, overall histograms of anisotropy values for all treated and all untreated cells show significant differences resulting from cytochalasin-D treatment.

FIG. 10 illustrates anisotropy histograms of individual cells. All molecules localized in the given cell are included in each histogram, and corresponding cell images are indicated. Note that all structures visible below ˜250 nm would be unresolved in a conventional fluorescence microscope.

When interpreting anisotropy values, probe rotational mobility is an important consideration. Even in fixed samples, fluorescent probes not attached to cell structures by multiple fixative cross-links may be capable of limited motion. Because the rotational time constant for fluorescent proteins in cells is typically on the nanosecond timescale, the emission from a given orientation of the probe will be sampled thousands of times during a single frame. Hence, the measured anisotropy will reflect the range of orientations accessible to the probe. For fixed samples, fewer orientations will be accessible, and the anisotropy values will be significantly different from the values observed for freely diffusing molecules in solution.

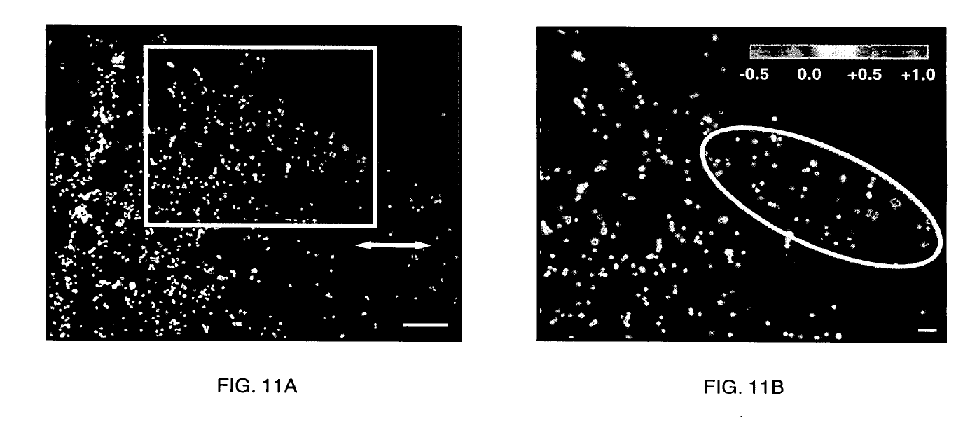

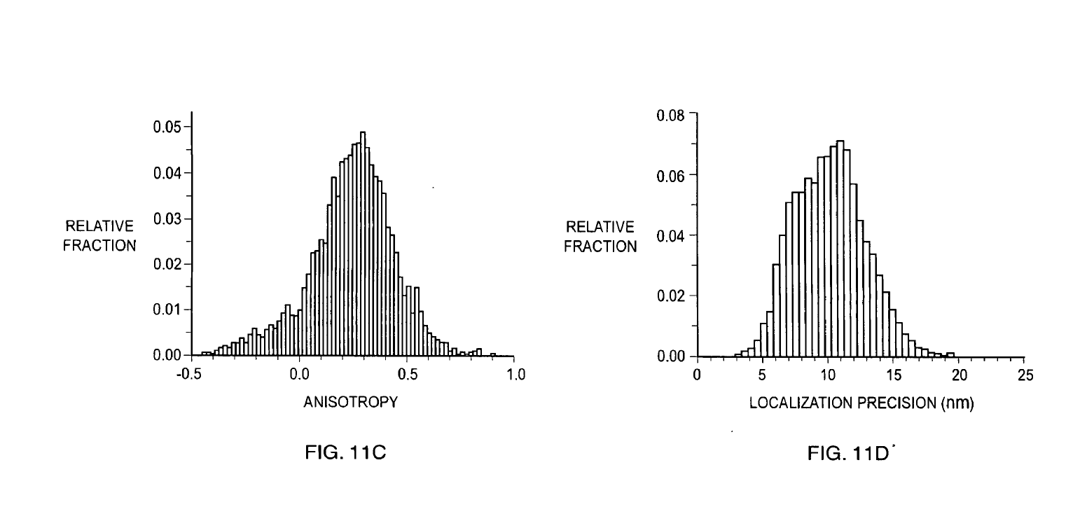

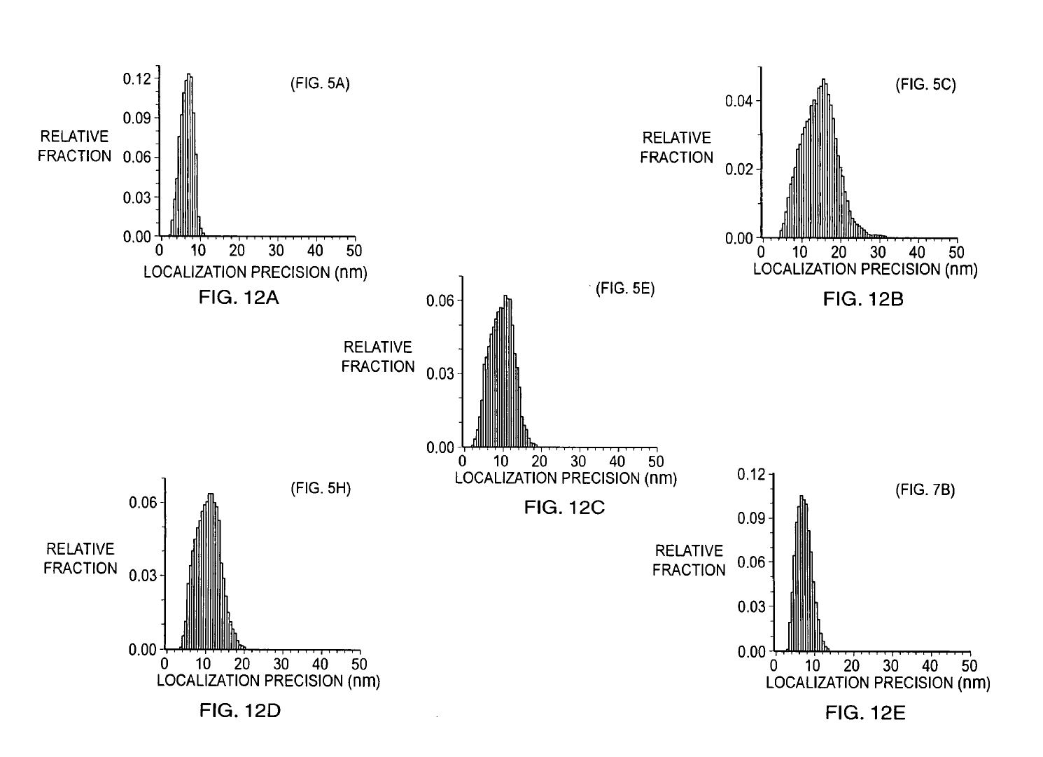

A P-FPALM image of the anisotropy of PGFP-tagged hemagglutinin (HA) in a fixed fibroblast is shown in FIG. 11A (1,601 molecules), where the direction of polarization for the readout beam is indicated by the double headed arrow. FIG. 11B shows a zoom-in of the boxed region in FIG. 11A of 412 molecules. FIG. 11C is a distribution of single molecule anisotropies for all molecules localized in the cell shown in FIG. 11A, and FIG. 11D is a distribution of localization for all molecules shown in FIG. 11A as calculated by Equation 2, discussed below. The ellipse in FIG. 11B shows an example of a cluster of molecules with similar anisotropy values, positioned near the edge of the cell, approximately ˜1 μm×2 μm in size. The spatially heterogeneous distribution of molecules in this cluster has particularly low (close to zero or negative) anisotropy values. The surrounding clusters of molecules show larger values of anisotropy. These spatially-dependent differences in anisotropy could be useful for understanding the formation of clusters of HA in membranes, which are used by the influenza virus to gain entry into host cells, and to assemble the components to build a new virus that will eventually bud from the host cell. Relative orientation of HA molecules could certainly be an important mediator of cooperation in membrane remodeling processes.

As long as the limitations of the method are taken into account, we can use the anisotropy to estimate the degree of alignment (but not the precise angle) between the transition-dipole moment of the emitting molecule and the excitation laser beam polarization. The improved resolution in P-FPALM described above (effective resolution of 17 nm is demonstrated, see Equation 4 discussed below) will allow quantification of order of proteins and lipids in membrane domains at length scales inaccessible to standard methods, and is a tremendous improvement in the art.

### Calculations Useful in Carrying Out the Invention

### 1. G-Factor:

The emission filter transmissions may vary somewhat within and between instruments. This causes bias in the polarization values. The bias is also assay dependent (i.e. viscosity). To correct for this, the G-factor is calculated from results obtained from pure fluorophore solution.

To measure the relative transmission efficiencies of polarizations, i.e., the G-Factor, those skilled in the art can carry out appropriate control experiments. For example, a ˜632 nm laser mounted with a polarizer directly in front of the exit aperture was used to generate a beam with either parallel or perpendicular polarization. The mirrors M2, M3, M4 and the polarizing beam splitter were separately placed in front of the polarized 632 nm laser and the incident, reflected, and transmitted (for BS only) powers were measured to calculate the reflection efficiency for mirrors and both the reflection and transmission efficiencies of the BS.

Light from the halogen lamp normally used for transmitted light illumination was first directed through a linear polarizer (#5511, New Focus, San Jose, Calif.) and band-pass filtered (HQ605/70M, Chroma). The linearly polarized, filtered light then passed through the condenser, the microscope objective, the filter cube consisting of the same dichroic filter (T565LP, Chroma Technology, Rockingham, Vt.) and emission filter (HQ605/70M, Chroma) used for normal acquisition, followed by the tube lens, side-port mirror, L2, and an analyzer, to finally strike a power meter placed at the focus of L2. Using the analyzer in the horizontal and vertical positions, the transmitted powers for x- and y-polarizations (at the sample) were measured to find relative transmission efficiency of the optical system (up to L2) as a function of polarization. Multiplying the measured relative efficiencies of each optical element, the final intensity correction necessary for the parallel and perpendicular beam components (G) was calculated. The overall efficiency was confirmed by imaging a pinhole of 50 μm diameter mounted in the field plane between the microscope transmission lamp (IX2-ILL100, Olympus) and the sample. From the image of the lamp in both detection channels, the relative detection efficiency of the parallel and perpendicular detection pathways was calculated.

### 2. Comparison of Measured Anisotropy Values With Known Values From Literature

Dilute solutions of Rhodamine B (RB) in water and in 85% glycerol were placed in a sample chamber and illuminated with the 556 nm laser under the same conditions used for acquisition and measurement of the beam profiles, except that the total power at the sample was 8 μW for the RB in 85% glycerol and 25 μW for the RB in water. Images of fluorescence detected with polarization parallel to the laser (image T, y-polarized) and perpendicular to the laser (image R, x-polarized) were recorded using the iXon+ camera. The detected fluorescence in images T and R was averaged along a strip 20 pixels wide (˜1.7 μm at the sample) passing through the peak of each image of the fluorescence induced by the laser. These profiles were fitted as a sum of two one-dimensional Gaussians each with center position, width, and amplitude as fitting parameters, as well as a single offset. The amplitudes A₁ and A₂ correspond to the peak intensities in T and R, respectively. The amplitude A₂ was corrected using the relative detection efficiency G=1.23 of the two polarizations (see page 299 of Lakowicz, J. R., Principles of fluorescence spectroscopy (Plenum Press, New York, 1983)), as determined from direct measurement of the transmission efficiencies of the optical components in the detection pathway (see above).

The ratio of corrected amplitudes ρ=(I_{∥})/(I⊥)=G·A₁/[A₂(1−λ_{BT}) was used to calculate the anisotropy of the solutions, where λ_{BT}=0.026 accounts for the measured bleed-through of the beam splitter at approximately the wavelength of detection. The resulting anisotropy r=(ρ−1)/(ρ+1) was determined for RB in water to be r_{RBW}=0.052±0.024, and in 80% glycerol to be r_{RBG}=0.324±0.025, in agreement with published values, converting from polarization (p) into anisotropy using r=2p/(3−p). These measurements establish that the method can provide accurate (absolute) anisotropy values within an estimated uncertainty of ±0.025.

### 3. Image Analysis:

As shown in FIG. 1, each image has two regions (T and R) corresponding to light transmitted and reflected by the polarizing beam splitter, respectively. Images of 100 nm fluorescent beads were analyzed to determine the coordinate transformation required (including displacement, linear stretching in x and y, and rotation) to superimpose a chosen region of interest (ROI) in T with the corresponding ROI in R. According to the measurements made, the required additional stretching on a given direction was <10% and the rotations were <6°.

The image R is transformed to yield R′, and then the sum of T and R′ is analyzed using standard single-molecule localization routines. The sum of T and R′ is used to localize molecules, rather than the individual images to utilize the total number of detected photons during localizations. Summing the images also recaptures the approximate 2D Gaussian profile of the point spread function whereas the individual images of polarization components are susceptible to ellipticity and other distortions due to probe orientation.

Bright objects identified as single molecules by intensity and size thresholding were localized and their positions and intensities determined. The image of each identified molecule was least-squares fitted using a two-dimensional Gaussian. Although the use of high numerical aperture (NA) objectives results in significant deviations from the 2D Gaussian approximation of the point spread function (even for molecules oriented in-plane) and leads to additional positional uncertainty, the use of a slightly lower NA objective (1.2 NA rather than 1.4 NA) helps minimize orientation-induced position-error for Gaussian fits to <2.5 nm.

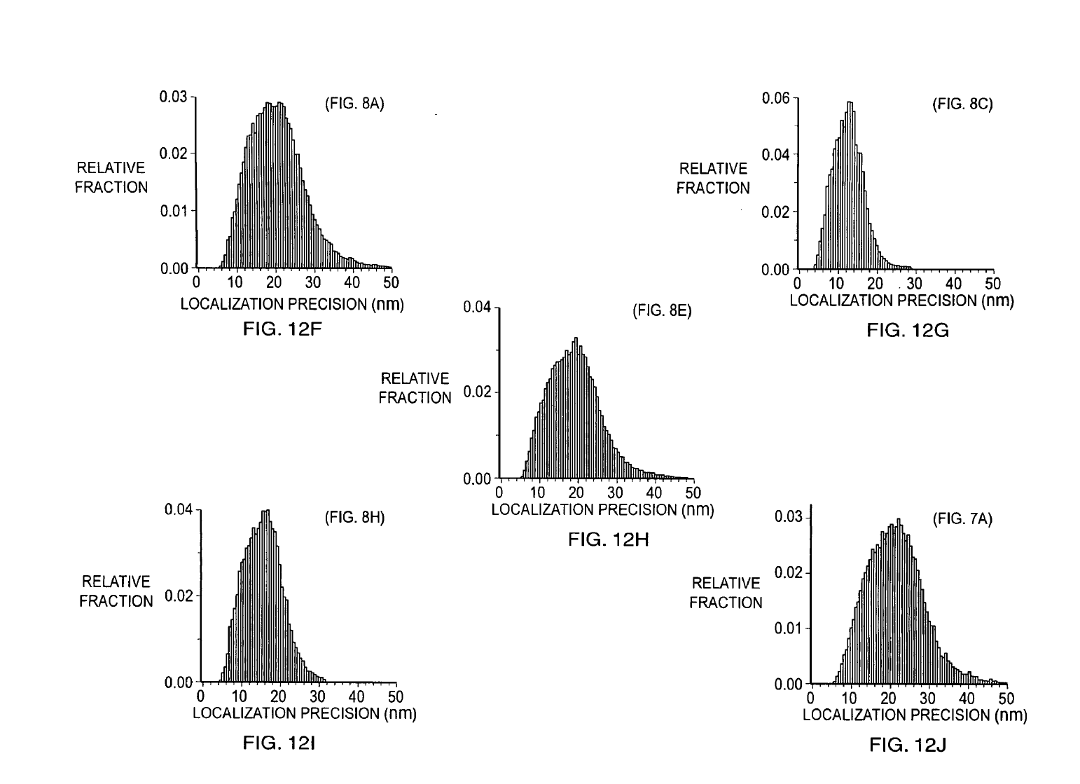

Quantitatively, the localization precision is calculated using:

$${σ}_{xy}^{2} = \frac{{s}^{2} + {q}^{2} / 12}{N} + \frac{8 π {s}^{4} {b}^{2}}{{q}^{2} {N}^{2}} \qquad Equation 2$$

where σ_{xy} is the precision with which a fluorescent object can be localized in two dimensions, s is the standard deviation of the point spread function, N is the total number of photons collected, q is the size of an image pixel within the sample space, and b is the background noise per pixel. FIG. 12 shows the distribution of localization precision calculated from Equation 2 for each cell appearing in a FIGS. 4, 5, 7 and 8.

For each localized molecule, N was calculated as the product of the 2D Gaussian amplitude and area. For the relatively low noise levels encountered in these experiments, summing the counts in the pixels containing the image of a single molecule to obtain N yields results consistent with the number calculated from the fitted amplitude of the 2D Gaussian. For each cell, b was assumed to be constant and taken as twice (due to the superposition of T and R for localization) the standard deviation in intensity (measured in photons) of the image of a cellular region in T where only background fluorescence (and no PGFP or Dendra2) was visible. Sample stage drift (<7 nm in x or y over ˜20 min.) was characterized previously and was minimal over the relatively short (<5 min.) duration of these experiments, compared to the estimated resolution of ˜17 nm (see below). Alternatively, stage drift can be compensated by recording the transmitted light image with a detector and localizing one or more features in the transmitted light image as a function of time. The position(s) of the localized feature(s) are then averaged over a timescale of approximately a second and then subtracted from the coordinates of the single molecules to correct for the drift of the entire sample.

Components of the fluorescence detected parallel (I_{∥}) and perpendicular (I⊥) to the linearly polarized readout lasers were mapped directly to either the direction transmitted (I_{∥} for 556 nm readout, I⊥ for 488 nm readout) through the polarizing beam splitter, or to the direction reflected (I⊥ for 556 nm readout, I_{∥} for 488 nm readout) by the polarizing beam splitter. To calculate anisotropy values, I_{∥} and I⊥ were determined by correcting the appropriate detection channel (depending on the readout source) for relative detection efficiency, bleed through of the transmitted channel into the reflected channel, and if applicable, the change in image area due to stretching upon coordinate transformation.

### 4. Image Rendering:

P-FPALM images were generated by plotting the coordinates of localized molecules as intensity-weighted Gaussian spots of width proportional to the calculated localization precision and shaded according to the calculated anisotropy value. Alternatively, an image of the data can be created by rendering the pixels within the FPALM image with a shade corresponding to the average anisotropy within that pixel.

For optimal localization-based resolution, a high density of localized molecules is necessary in addition to precise localization. A modified localization-based resolution can be defined as:

r_{L}²=σ_{xy}²+r_{NN}² Equation 3

where r_{L} is the localization-based resolution, σ_{xy} is the localization precision (from Equation 2), and r_{NN} is the nearest-neighbor distance. For example, in FIG. 5H, there were 1,136 molecules localized in area of 0.28 μm² (conservatively estimating the area of the fiber), which yields a density of ˜4,057 μm² and an average nearest neighbor distance of ˜15.7 nm. For this experiment, the median localization precision was ˜7 nm, which yields an effective resolution of:

r_{L}=√(σ_{xy}²+r_{NN}²)=√{(7 nm)²+(16 nm)²}=17 nm Equation 4

so that the localization precision actually does not limit the resolution, and use of the localization precision alone as an estimate of effective resolution would be improper.

### 5. Calculations Accounting for the Effects of Polarization Tipping

Because single molecules are being localized using two detection channels (three channels are required to determine the full orientation in three dimensions), anisotropies measured for molecules which are oriented with a component out of the x-y plane will only be approximate, due to tipping of the polarization by the high-numerical aperture objective. As a result, the anisotropies cannot be interpreted directly as an angle relative to the laser polarization axis. The following calculations, using numerical simulations of detected fluorescence from single molecules, account for the effects of polarization tipping and allow specification of the range of orientations the molecule could have, within experimental error, when close to the center of the field. Use of at least three detection channels allows determination of the full three-dimensional orientation of the molecules.

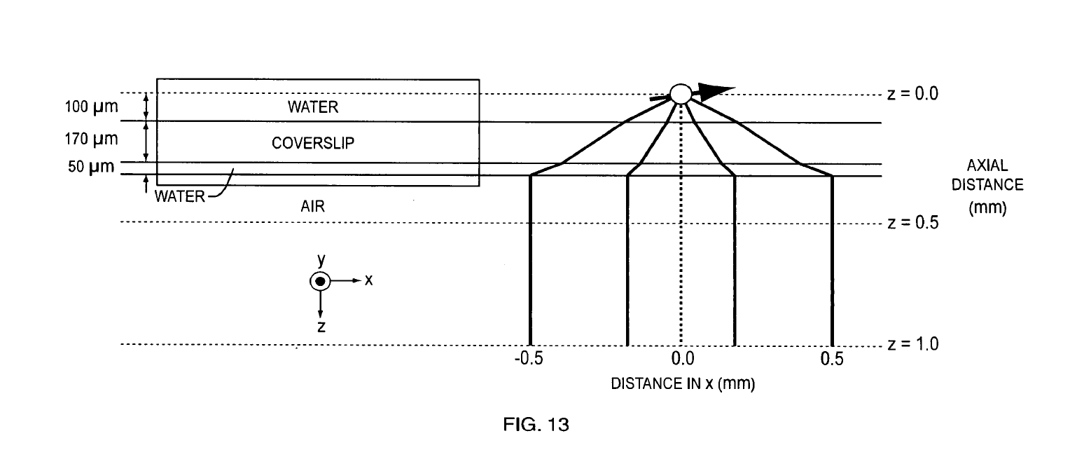

Calculation of the Detected Fluorescence. A point-like fluorescence emitter with time-dependent dipole moment p̅(t)=Re{ p̅₀ e^{i\acute{ω}t}} was positioned at location \vec{r}=(xₚ, yₚ, Zₚ) relative to the coordinate origin (the focus of the objective lens) oriented in direction \hat{p}. This can be seen in FIG. 13, where a single molecule near the focus of a high-NA objective (circle) lens emits dipole radiation according to its transition dipole moment (arrow). The radiation pattern of that dipole was calculated using:

$$\vec{E} = - {( ω / v )}^{2} \frac{1}{{r}^{3}} {r}^{->} \times ( {r}^{->} \times {p}^{->} ) \qquad Equation 5$$

where the ratio of angular frequency ω to wave propagation velocity v was defined to be unity and \vec{r} is the vector between the observation point and the dipole position.

The magnitude and direction of the electric field was calculated at a distance of 50 μm from the dipole along rays projecting radially away from the dipole (and toward the objective lens; see FIG. 13). As shown in FIG. 13 the electric field generated by this dipole is calculated and propagated through the interfaces using the Fresnel equations, and the propagation direction is shown with four rays. For each ray propagating away from the dipole within a cone of angle α measured from the z-axis, the components of the electric field were calculated progressively at each interface using the Fresnel formulae:

$$\begin{matrix}{T}_{\vert \vert} = \frac{2 {n}_{1} cos {θ}_{i}}{{n}_{2} cos {θ}_{i} + {n}_{1} cos {θ}_{t}} {A}_{\vert \vert} & Equation 6 a \\ {T}_{⊥} = \frac{2 {n}_{1} cos {θ}_{i}}{{n}_{2} cos {θ}_{i} + {n}_{1} cos {θ}_{t}} {A}_{⊥} & Equation 6 b\end{matrix}$$

where T_{∥} and T⊥ are the transmitted electric field components parallel and perpendicular to the plane of incidence, and A_{∥} and A⊥ are the components of the incident wave parallel and perpendicular to the plane of incidence, respectively, n₁ and n₂ are the indices of refraction of the wave on the incident and transmitted sides of the boundary, respectively, and θᵢ and θₜ are the angles between the surface normal of the interface and the incident and transmitted wave propagation vectors, respectively. The new direction of propagation was calculated using the law of refraction. Rays were detected within a cone of angle α=64.2° (1.12 radians) measured relative to the z-axis, yielding a numerical aperture (NA) of 1.2 for the lens (NA=n sin α, where n is the refractive index of the objective immersion fluid, n=1.33 for this case).

As can be seen in FIG. 13, the interfaces were: water-glass at z=100 μm, glass-water at z=270 μm, and water-lens-air at z=320 μm (where the rays enter the objective lens). The refractive indices used for water and glass were 1.33 and 1.5, respectively. The objective lens was treated as an ideal, thin lens, whereby all rays emitted from the focus of the lens became parallel upon striking the front surface of the lens, and the electric field was calculated using Equations 6a and 6b for a single surface in the xy-plane. The thickness of the lens was assumed to be negligible, and the light emerging from the lens is assumed to be propagating in air.

The magnitude of the components of the electric field detected from a dipole with orientation \hat{p} and located at \vec{r}ₚ are integrated separately within a circular aperture at the rear of the lens, each ray weighted by the area subtended in the back aperture:

$${\vec{E}}^{det} ( {{r}^{->}}_{P} , \hat{p} ) = {\int }_{θ = 0}^{2 π} {\int }_{s = 0}^{{R}_{BA}} \vec{E} ( s , θ , {{r}^{->}}_{P} , \hat{p} ) s d s d θ \qquad Equation 7$$

where s is the distance from the center of the back aperture (measured perpendicular to the z-axis), and θ is the polar angle in the x-y plane measured from the x-axis. Typically, the circular back aperture is divided into 80 rings spaced evenly as a function of angle measured from the z-axis and 80 evenly-spaced values of θ (6400 total rays per condition). Increasing the number of rays calculated yielded results equal within three or more digits of precision. The components of \vec{E}^{det} are then calculated as a function of position of the dipole emitter (\vec{r}ₚ) for dipole emitters oriented in the x, y, and z directions. The detected electric field for an arbitrarily oriented dipole is calculated as an appropriate linear superposition of those detected electric field components. The detected intensity in the parallel (I_{∥}) and perpendicular (I⊥) channels is then proportional to the square of Eₓ and E_{y}, respectively. The detected electric field is calculated as a function of dipole position in a grid of 100 μm×100 μm in the x-y (sample) plane with uniform 0.5 μm spacing in both x- and y-directions, and linearly interpolated for points in between.

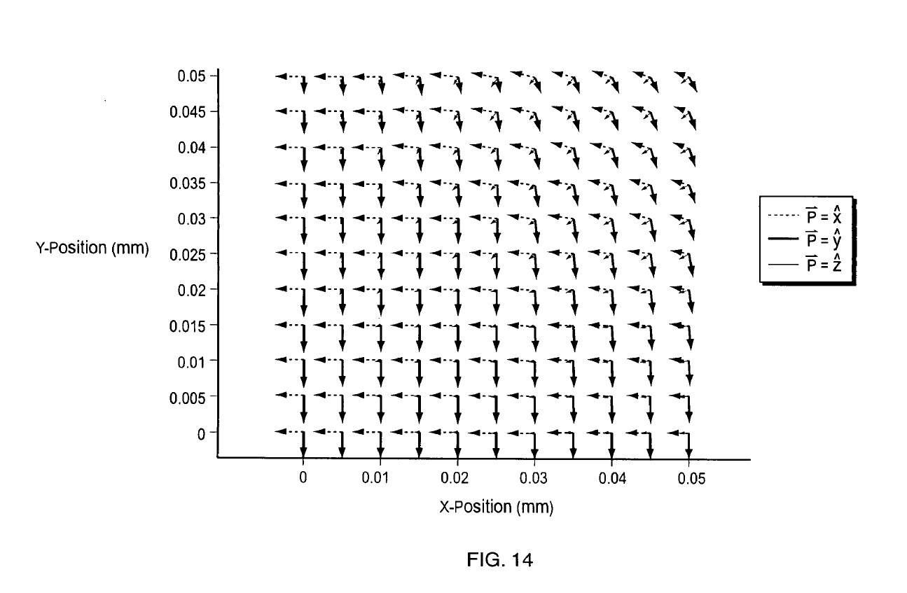

Results for a 1.2 NA water-immersion objective lens are shown in FIG. 14 for dipole-like emitters oriented along the x-, y, and z-axis, for dipole displacements in x and y from 0 μm to +50 μm from the center of the field (on-axis focus of the objective). Note the significant rotation of the detected electric field compared to the dipole alignment when the dipole is far (>15 μm) from the center of the field, and the significant tipping of the detected electric field relative to the dipole moment that occurs when the dipole is displaced significantly (i.e. >20 μm radially) from the center of the field. In all cases, P-FPALM measurements of anisotropy were made at distances less than 15 μm from the center of the field.

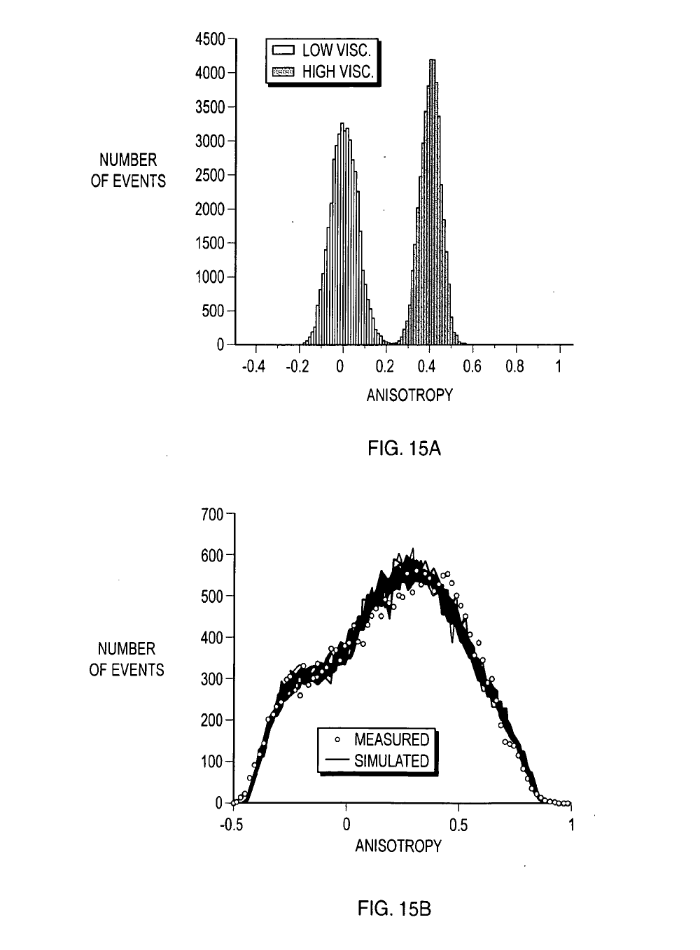

Monte-Carlo Simulations of Single-Molecule Emission. The measured anisotropy values of single molecules correlate well with Monte-Carlo simulated values, as discussed below and shown in FIG. 15. FIG. 15A show simulated anisotropy histograms for a standard fluorophore with random orientation in solution at low viscosity (light bars), such that complete randomization of the fluorophore orientation occurs before emission (dark bars). At high viscosity, the fluorophore does not reorient, and emits as a dipole moment parallel to the transition dipole moment. The simulation includes the effect of rotation of the electric field by the objective lens. The mean anisotropies of 0.0016 and 0.4002 for low and high viscosity, respectively, are in good agreement with predictions from theory in low-NA systems and with measurements made on RB in solution. FIG. 15B shows a measured anisotropy histogram for PGFP immobilized on glass (circles) and as described by simulations (lines showing ten independent simulation runs) using two populations of photoactivatable molecules with non-random orientation.

Single molecules were distributed randomly within a square area 40 μm×40 μm illuminated by an electric field polarized in the x-y plane with a two-dimensional Gaussian intensity distribution with a 1/e² width of 15 μm, centered at x=y=0, in the focal plane (z=0) of the objective lens. The absorption dipole moment \hat{p}_{abs} of each molecule is oriented using a pseudo-random number generator which on the average produces a uniform angular distribution of unit vectors, or a non-uniform distribution spanning a certain range of angles (see below). For each run, Nₘₒₗ, molecules are initially assigned either (A) for PGFP, to the inactive (non-fluorescent) state or (B) for RB, to the active (fluorescent) state. During each Monte-Carlo step, the probability of PGFP photoactivation P_{PA} is calculated:

P_{PA}=P_{PA0}|\vec{E}ᵢₗₗᵤₘ(\vec{r}_{P})·\hat{p}_{abs}|²/|\vec{E}ᵢₗₗᵤₘ(\vec{r}ₚ=0)|² Equation 8

such that the per-step probability of photoactivation at the origin (focus of the objective) is equal to P_{PA0} when the dipole is aligned with \vec{E}ᵢₗₗᵤₘ, the E-field due to the illumination light. Rhodamine molecules are already in the active state, so P_{PA} is by definition zero.

The probability of photobleaching of each active molecule is calculated using:

P_{PB}=P_{PB0}|\vec{E}ᵢₗₗᵤₘ(\vec{r}_{P})·\hat{p}_{abs}|²/|\vec{E}ᵢₗₗᵤₘ(\vec{r}ₚ=0)|² Equation 9

where P_{PB0} is the per-frame probability of irreversible photobleaching at the origin for a dipole perfectly aligned with the illumination electric field. Values of P_{PB0}=0 are used to model rhodamine in solution, where the illumination intensity is low, and the rate of photobleaching is therefore negligible. Values of P_{PA0}=0.3, P_{PB0}=0.01 are used for PA-GFP immobilized on glass. All fluorescent molecules are treated as dipole emitters with unit emission dipole moment, which may or may not be aligned with the absorption dipole moment (see below). The detected fluorescence in the parallel and perpendicular channels is calculated using the position and orientation of the dipole, with detected electric field given by:

\vec{E}ₚ⁽ⁱ⁾=[\vec{E}ᵢₗₗᵤₘ(\vec{r}ₚ⁽ⁱ⁾)·\hat{p}_{abs}⁽ⁱ⁾]\vec{E}_{det}(\vec{r}_{P}⁽ⁱ⁾,\hat{p}ₑₘ⁽ⁱ⁾) Equation 10

where \vec{r}ₚ⁽ⁱ⁾⁾ is the location of the i-th dipole. For mobile molecules at high viscosity, the absorption dipole moment \hat{p}_{abs} is randomized between successive acquisition frames, and the emission dipole orientation \hat{p}ₑₘ is set equal to that of the absorption dipole. For mobile molecules at low viscosity, the absorption dipole and emission dipole are both randomized independently between each frame.

The intensity detected from all active molecules (the fluorescence emission is assumed to be incoherent) in the parallel and perpendicular channels is calculated using:

I_{∥}⁽ⁱ⁾=c|Eₚₓ⁽ⁱ⁾|² Equation 11a

I⊥⁽ⁱ⁾=c|E_{py}⁽ⁱ⁾|² Equation 11b

where c is a constant, and i is an index over all active molecules. The measured anisotropy of each molecule is then calculated using:

r⁽ⁱ⁾=(I_{∥}⁽ⁱ⁾−I⊥⁽ⁱ⁾)/(I_{∥}⁽ⁱ⁾+2I⊥⁽ⁱ⁾ Equation 12

After 30-200 simulated acquisition frames, the molecules are re-initialized and the next run is commenced. From the values of anisotropy for each molecule, an intensity-weighted histogram of anisotropies is calculated.

Simulation results for dye in solution (randomly oriented, Nₘₒₗ=50,000) are shown for the low-viscosity and high-viscosity limits (FIG. 15A). In the low-viscosity limit, molecules reorient rapidly before emitting fluorescence, resulting in a complete loss of the initial polarization direction, and emission with zero mean anisotropy (rₐᵥₑ=0.0016). In the high-viscosity limit, molecules do not reorient before emitting, leading to emission from a dipole emitter oriented parallel to the excitation transition dipole moment, and positive mean anisotropy (rₐᵥₑ=0.4002) in agreement with predictions from analytical theory.

Importantly, these simulations take into account the rotation of the electric field vector resulting from passage through the media, coverslip, immersion liquid, and objective lens. Simulated anisotropy histograms for PA-GFP immobilized on glass (FIG. 15B) agree fairly well with the measured histogram for 22,476 molecules using: two-dimensional circular Gaussian beam illumination 1/e² radius r₀=12 μm, Nₘₒₗ=22,476 total molecules distributed randomly over a 10 μm×10 μm square area, 30 frames per acquisition, and two populations of molecules. The first population of 7,417 molecules had an orientation of 15° relative to the z-axis and an angle of φ=51±16° measured from the x-axis. The second population of 15,059 molecules also had an angle of 15° relative to the z-axis and an angle of φ=27±12° measured from the x-axis in the x-y plane. These populations and orientations are not necessarily the unique or best description of the measured histogram. The measured anisotropy histogram was not well-described by a single population or by two populations of molecules with random orientation.

### 6. Error in Anisotropy Values Measured Using High NA Optics

Unambiguous measurement of the three dimensional orientation of a single molecule can be accomplished by detecting the fluorescence emission polarized along three different directions. The anisotropy values presented here, measured with two polarizations, provide a reasonable approximation to the anisotropy while maintaining a good signal to noise ratio. The mixing of fluorescence emitted parallel and perpendicular to the excitation source increases significantly as dipole orientation approaches alignment parallel to the optical axis, although the thresholding inherent to localization-based imaging also results in low probabilities of detection of molecules that are closely aligned to the optical (z-) axis and weakly excited.

Using the methods described above, the detected intensities in the parallel and perpendicular channels were determined as a function of probe position and orientation near the center of the field in the x-y (focal) plane. The detected intensity was calculated from the electric field outside the back aperture of the objective lens (Eq. S6):

$$\begin{matrix}{I}_{\vert \vert}^{det} ( {{r}^{->}}_{P} , \hat{p} ) = {\int }_{θ = 0}^{2 π} {\int }_{s = 0}^{{R}_{BA}} {\vert {E}_{x} ( s , θ , {{r}^{->}}_{P} , \hat{p} ) \vert}^{2} s d s d θ & Equation 13 a \\ {I}_{⊥}^{det} ( {{r}^{->}}_{P} , \hat{p} ) = {\int }_{θ = 0}^{2 π} {\int }_{s = 0}^{{R}_{BA}} {\vert {E}_{y} ( s , θ , {{r}^{->}}_{P} , \hat{p} ) \vert}^{2} s d s d θ & Equation 13 b\end{matrix}$$

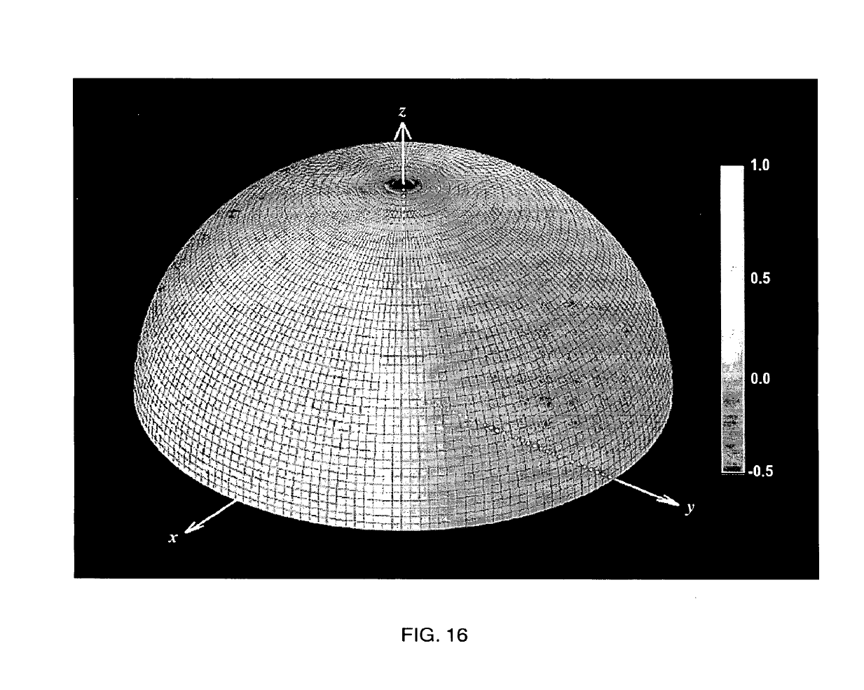

and from the parallel and perpendicular intensities, the anisotropy was calculated using Equation 12. The dipole axis unit vector was oriented with angle θ relative to the z-axis and angle Φ relative to the x-axis measured in the x-y plane. Values of the anisotropy were calculated for θ=0 to 90° and Φ=0 to 90° in 2° increments. The intensities in Equations 13a and 13b take into account the tipping of the electric field by the high-NA objective, as well as effects from the water-coverslip, coverslip-water, and water-objective interfaces. The expected (calculated) detected anisotropies are shown as a function of probe orientation in a grey scale-coded plot (FIG. 16) and demonstrate that despite the rotation of the polarization by the objective lens, a particular anisotropy value measured at a particular location close to the center of the field corresponds to a certain set of probe orientations. In FIG. 16, the anisotropy expected for a single molecule (dipole emitter) at the center of the field was calculated using Equation 7 and Equations 13a and 13b, and is shown as a function of probe orientation. Note that the polarization of the laser is along the x-axis. The grey scale on the surface of the sphere indicates the detected anisotropy value (see scale bar) for a molecule with transition dipole moment pointing from the origin to the surface at that point. Note that symmetry dictates the anisotropy values for other orientations not shown (i.e. a molecule with exactly opposite transition dipole moment will have the same expected detected anisotropy).

While a measurement of a single anisotropy value will not decisively identify the exact orientation of the probe in three dimensions, the anisotropy value does provide useful information about which orientations the probe could have. Small displacements (<7 μm) from the center of the field result in variability of less than 0.01 in anisotropy at any given θ or Φ value. Two molecules with anisotropy values different by more than the experimental uncertainty are therefore in different orientations.

It is to be understood that various modifications may be made to the system and method described above without departing from the spirit and scope of the invention. For example, the steps of the method may be performed in differing order, one or more steps may be omitted, and one or more steps may be replaced with alternative forms thereof. Accordingly, other embodiments are within the scope of the claims appended hereto.

1-22. (canceled)

23. A system for imaging the position and anisotropy of single molecules in a sample, the system comprising:
a. a two-dimensional Fluorescence Photoactivation Localization Microscopy (FPALM) system including an illumination light source, an imaging lens, and a lens to form an intermediate image;
b. a polarizing beam splitter to separate detected fluorescence into the polarization components of the detected fluorescence, including but not limited to the parallel and perpendicular components;
c. one or more mirrors to control the path length for both components of the detected fluorescence and either (i) make the path length equal or nearly equal for both paths or (ii) deliberately different for the two paths to allow three-dimensional position information to be determined for the molecules; and
d. a detector.

24. The system of claim 23, wherein the system further comprises one or more lenses to magnify the intermediate image.

25. The system of claim 23, wherein the light source is one or more lasers.

26. The system of claim 23, wherein the imaging lens is a water immersion lens.

27. The system of claim 23, wherein the imaging lens is an oil immersion lens.

28. The system of claim 23 wherein the imaging lens is a high-numerical aperture lens.

29. The system of claim 23, wherein the system is configured for focusing the light source at the back aperture of the imaging lens so that a large area of the sample is illuminated.

30. The system of claim 23 wherein the detector is a camera.

31. The system of claim 23, wherein the illumination light source is modulated.

32. The system of claim 31, wherein polarization of the illumination light source is modulated.

33. The system of claim 31, wherein a wavelength of the illumination light source is modulated.

34. A method for imaging the position and anisotropy of single molecules in a sample in a system comprising system comprising a two-dimensional Fluorescence Photoactivation Localization Microscopy (FPALM) system including a light source; an imaging lens; a lens to form an intermediate image; a polarizing beam splitter to separate detected fluorescence into the polarization components of the detected fluorescence, including but not limited to the parallel and perpendicular components; one or more mirrors to control the path length for both components of the detected fluorescence and either (i) make the path length equal or nearly equal for both paths or (ii) deliberately different for the two paths to allow three-dimensional position information to be determined for the molecules; and a detector; the steps of the method comprising:
a. preparing a sample tagged with a suitable fluorophore;
b. illuminating the sample with a suitable light source; and
c. calculating the anisotropy of the molecules from the ratio of fluorescence emitted by the molecule with polarization parallel and perpendicular to a reference axis.

35. The method of claim 34, comprising the additional step of calculating the localization of single molecules using standard FPALM single-molecule localization routines.

36. The method of claim 34, comprising the additional step of calculating the localization precision.

37. The method of claim 36, wherein the localization precision is used to correct for stage drift.

38. The method of claim 34, wherein a biological sample is measured.

39. The method of claim 38, wherein a living biological sample is measured.

40. The method of claim 39, wherein a lipid bilayer is measured.

41. The method of claim 39, wherein a nanostructure is measured.

42. The method of claim 35, wherein the three-dimensional position of the molecules is also determined.
